(19) United States
(12) Patent Application Publication
(10) Pub. No.: US 2006/0040656 A1
(43) Pub. Date: Feb. 23, 2006

(54) Mechanism for hand off using access point detection of synchronized subscriber beacon transmissions

(76) Inventor: Michael D. Kotzin, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/919,896

(22) Filed: Aug. 17, 2004

(51) Int. Cl. H04Q 7/20

(52) U.S. Cl. 455/426.2

(57) ABSTRACT

A WLAN access point (111) is synchronized with a Wide Area Network (WAN) (105) via either a backhaul connection (115), or via hardware of the WLAN access point (111) suitable for receiving and decoding a synchronization timing signal from the WAN (105). The WLAN access point (111) may then transmit a beacon signal during a defined time window. The mobile station (101) is aware of the time window and only powers its WLAN transceiver equipment on during the appropriate window. Because the WLAN access point (111) is synchronized to the WAN (105), the mobile station (101) is able to anticipate the appropriate time window for power up. When the mobile station detects the WLAN access point (111) beacon, it notifies the WAN (105), via a WAN base transceiver station (BTS) (107) and proceeds to hand over idle mode signaling from the serving BTS (107) to the WLAN access point (111)

### RELATED APPLICATIONS

This application relates to U.S. Non-Provisional application Ser. No. 10/903,819, filed Jul. 30, 2004, titled APPARATUS AND METHOD FOR OPERATING A COMMUNICATION DEVICE ON TWO NETWORKS, and U.S. Non-Provisional application Ser. No.______, filed Aug. 17, 2004, titled MECHANISM FOR HAND OFF USING SUBSCRIBER DETECTION OF SYNCHRONIZED ACCESS POINT BEACON TRANSMISSIONS (Attorney Docket No. CS24074RL), which are commonly owned by the same assignee and incorporated by reference herein.

### FIELD OF THE INVENTION

The present invention relates generally to cellular and wireless local area networks, and more particularly to wireless local area network access points and handsets having dual mode wireless interface capability.

### BACKGROUND OF THE INVENTION

Wireless Local Area Networks (WLAN) were originally conceived for data connectivity, for example, connectivity of a personal computer (PC) to the Internet or an Intranet. However, the range of devices and applications that make use of WLAN connectivity has expanded to include voice communication, traditionally provided by cellular networks. Likewise, cellular networks are currently capable of providing data connection capability.

Various handheld devices, as well as laptop computers include wireless transceivers appropriate for establishing connectivity with WLANs. Cellular telephones currently exist that are Dual mode or Multi-mode in that such telephones comprise transceivers for communicating with cellular networks using air interfaces such as IS-95 and GSM, as well as transceivers for communicating with WLANs using air interfaces such as 802.11, Bluetooth, IrDA, and HomeRF.

A significant opportunity is the ability for a mobile device to seamlessly roam between the WAN and WLAN networks. The networks provide different characteristics that, depending on circumstances can be effectively exploited. For example, WAN network throughput is often limited and tariffed heavily. WLANs, on the other hand, provide high throughput with insignificant tariffs. If the mobile device, when it moves close to a WLAN access point can transfer it communications to the WLAN network, it can utilize much more throughput at lower cost. A key need therefore is an ability to seamlessly transition the mobile device from the WAN network to the WLAN network when it approaches a WLAN access point.

A problem with mobile devices is that they are battery powered and therefore have a limited operating time proportional to the size of battery utilized. Therefore, various mechanisms have been designed to limit the consumption of battery power. A cellular communications system for example, may incorporate several mechanisms for improving operating time of the mobile stations subscribed to the system.

An example mechanism for conserving mobile station battery power, is to limit the time that a mobile station's transceiver is powered on. For example, a mobile station in idle mode, in other words, not actively engaged in a call or data connection, must still use battery power to transmit and receive information to and from a wireless network. Specifically, the mobile device must enable its receiver to stay synchronized with and receive the WAN broadcast channel to receive pages, including the notification of incoming calls. The mobile station must also transmit and receive location update messages from the wide area cellular network as the mobile station moves from one potential serving cell or location area to another.

A mobile device's power dissipation is minimized by only energizing the receive circuitry periodically to receive the paging channel. Broadcast paging information is transmitted in a known way to ensure that information targeted to a particular mobile device occurs within a window of time that it is known the mobile device is receiving.

Also, although location update messaging requires mobile station battery power, the power consumption is less than it would be for a call because the update messaging occurs only during given time intervals. Therefore, the mobile station transceiver needs power only during the intervals that it must listen or transmit.

The WLAN technical communities have likewise standardized various battery power saving approaches for mobile stations. One such approach is passive scanning which is an approach used to determine availability of a nearby access point or access points. Rather than transmit request messages the mobile station listens in sequence, to a number of channels, and determines whether a beacon is being transmitted over any of the channels. The mobile station records the beacon information for any channel over which a beacon was received, and therefore knows which access point channel to either send an access request message to or to join. Although this mechanism saves the power required for transmitting, the WLAN transceiver must still expend power for scanning the potential beacon channels.

While the WAN and WLAN systems provide mechanisms for reducing power individually, no mechanism exists to coordinate cellular and WLAN power savings mechanisms for dual-mode or multi-mode mobile stations that communicate with cellular networks as well as WLANs. This is a critical need to provide seamless mobility, since while the mobile device is operating on the WAN system; it needs a method for detecting that it has moved within the range of a WLAN access point.

Therefore, a need exists for a method and apparatus for coordinating battery power saving mechanisms for dual-mode and multi-mode mobile stations that communicate using cellular and WLANs, particularly for WLAN access point detection.

### BRIEF DESCRIPTION OF THE DRAWINGS

FIG. 1 is a network block diagram illustrating a mobile station communicating with a Wireless Local Area Network (WLAN) access point and a Wide Area Network (WAN) Base Transceiver Station (BTS).

FIG. 2 is a block diagram of a WLAN access point in accordance with an embodiment of the present invention.

FIG. 3 is a block diagram of the high level operation of a first embodiment of the present invention.

FIG. 4 is a message flow diagram providing further details or operation of the first embodiment of the present invention with respect to FIG. 3.

FIG. 5 is a block diagram of the high level operation of a second embodiment of the present invention.

FIG. 6 is a message flow diagram providing further details or operation of the second embodiment of the present invention with respect to FIG. 5.

### DETAILED DESCRIPTION OF THE PREFERRED EMBODIMENTS

To address the above-mentioned need, an apparatus and method for reducing the battery power consumption of a mobile station during roaming between a cellular network and a WLAN is provided herein.

In accordance with a first embodiment of the present invention, a WLAN access point is synchronized with a wide area network (WAN) via either a backhaul connection, or via hardware of the WLAN access point suitable for receiving and decoding a synchronization timing signal from the WAN.

The WLAN access point may then transmit a beacon signal during a defined time window. The mobile station is aware of the time window and only powers its WLAN transceiver circuitry on during the appropriate window. Because the WLAN access point is synchronized to the WAN, the mobile station is able to anticipate the appropriate time window for power up. When the mobile station detects the WLAN access point beacon, it notifies the WAN, via a WAN base transceiver station (BTS) and proceeds to hand over idle mode signaling from the serving BTS to the WLAN access point.

In accordance with a second embodiment of the present invention, the mobile station transmits a WLAN beacon during the predetermined time window. A WLAN access point, operating with synchronization information and knowledgeable of the predetermined time window, detects the mobile station beacon and will then communicate with the cellular network infrastructure via a backhaul connection, to inform the cellular network that a mobile station has been detected.

The cellular network then sends a message to the mobile station to cause it to power up its WLAN transceiver and search for a WLAN. Upon successful detection and connection to the WLAN, the mobile station hands over from the cellular network to the WLAN. Further, the mobile station may use the access point beacon information to update a neighbor list or WLAN scan report, or equivalent and to disconnect from the cellular network and continue idle mode activity using the WLAN access point. For example, the mobile station may subsequently maintain location update messaging to the cellular network over a data frame of the access point.

The advantage of the present invention is that the mobile station may maintain its WLAN transceiver equipment powered off and need not transmit or receive WLAN messaging except during the predetermined time interval which is synchronized between an access point and the mobile station.

Other advantages are that the mobile station may also be pre-authenticated to the access point due to the backhaul communication between the access point and the cellular network such that only association or reassociation messaging is required to establish a WLAN traffic connection.

Turning now to the drawings wherein like numerals represent like components, FIG. 1 is a block diagram illustrating basic operation of the present invention. A mobile station 101 is in communication with a wide area network (WAN) 105 base transceiver station (BTS) 107 using an air interface 103. Air interface 103 may be for example, IS-95 CDMA, GSM, WCDMA, CDMA2000, etc. Mobile station 101 maintains communication with nearby BTS 107 when it is in an idle mode and sends and receives periodic messages for example, location update messages.

The WAN 105 comprises a number of BTSs as well as at least one mobile switching center (MSC) having a home location register, MSC/HLR 121 which controls handovers of mobiles stations between the various BTS cell sites. The WAN 105 may have a number of MSCs, each one forming a location area based on a number of BTS cell sites and a network plan. The control of the WAN 105 may also be further distributed internally via a number of base station controllers (BSCs) hierarchically positioned between a given number of BTS cell sites and an MSC as well as other location registers and network entities as are known in the WAN art.

In accordance with the embodiments of the present invention, the WAN 105 is coupled to one or more WLAN access points, such as WLAN access point 11 1, over a network 115 via connection 117 and connection 113. The network 115 may be any suitable one such as an Intranet, the Internet, the PSTN, etc. The backhaul connections 113 and 117 may be any suitable means such as point-to-point RF, infrared laser, Ethernet, DSL, cable, TI/El, ISDN, etc. The backhaul connection may be made to a specific WAN MSC, such as MSC/HLR 121 as appropriate based upon the MSC/HLR 121 physical location, the WAN network plan, or both.

The WLAN access point 111 may communicate over the backhaul and network 115 directly with the MSC/HLR 121 or may communicate through an intermediate WLAN gateway. A WLAN gateway may be connected to a number of WLAN access points forming a larger area of WLAN radio coverage, or a number of independent WLAN hot spot coverage areas.

The WLAN access point 111 communicates with mobile station 101 using air interface 109. Air interface 109 may be for example, 802.11, Bluetooth, HomeRF, or any other suitable interface. Mobile station 101 comprises two transceivers, one for communication with the WLAN access point 111 using air interface 109, and one for communication with the WAN 105 using air interface 103. Both transceivers of mobile station 101 may be simultaneously operated such that the mobile station 101 may be communicating with the WAN 105 and WLAN, via WLAN access point 111, simultaneously.

As mobile station 101 moves through the WAN 105 coverage area, periodic updates are transmitted and received by the mobile station to and from the WAN 105 respectively, using the WAN transceiver of mobile station 101. Alternatively, the mobile station 101 may be simply receiving paging messages or be involved in a call. In any case, the mobile station 101 is synchronized with the WAN 105, or more particularly with its serving cell BTS 107.

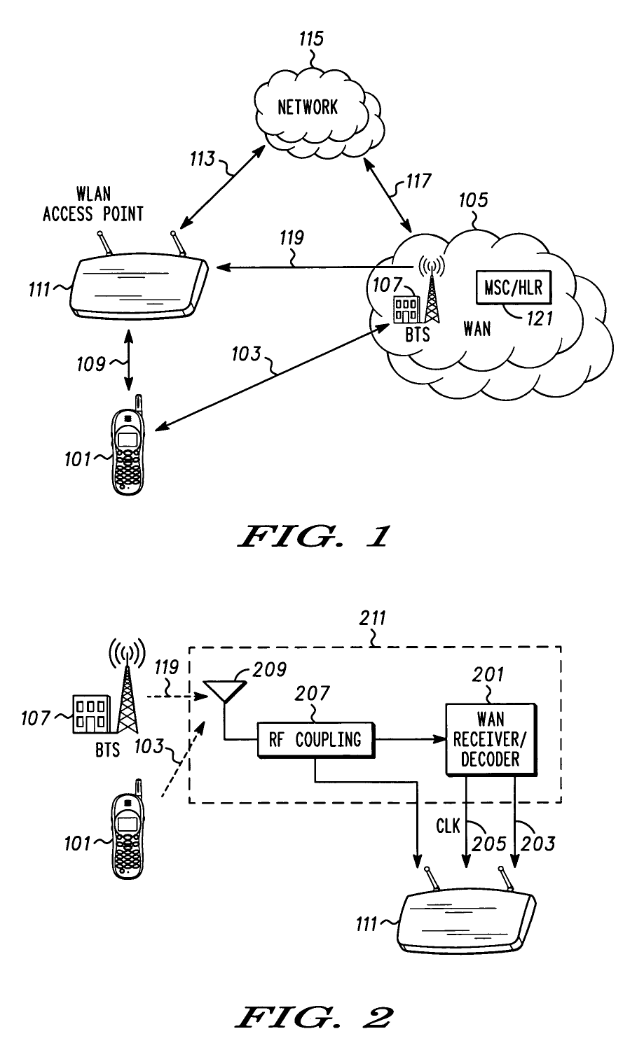

In the embodiments of the present invention, the WLAN 111 access point is also capable of synchronizing to the WAN 105 via either the network 115 connection or by a WAN receiver/decoder via received air interface signal 119. FIG. 2 illustrates an embodiment using a WAN receiver/decoder 201. The details of such a WAN receiver/decoder for a WAN using IS-95 has been described in U.S Patent Application Publication US2004/0081117 (published Apr. 29, 2004), U.S. application Ser. No. 10/282,654, Filed Oct. 29, 2002, commonly assigned to Motorola, Inc. and which is hereby incorporated by reference herein.

In FIG. 2, WAN receiver/decoder 201 provides a timing reset 203 and a clock (CLK) 205 signal to WLAN access point 111. The WAN receiver/decoder 201 is coupled to an antenna 209 via RF coupling circuitry 207. The RF coupling circuitry 207 may alternatively make use of an existing antenna of WLAN access point 111. The WAN receiver/decoder 201, RF coupling 207, and antenna 209 may be integrated into access point 111, or may be a separate removable circuitry such as a PCMCIA card 211.

In embodiments using the WAN receiver/decoder 201 for synchronization, the RF coupling device 207 receives the BTS 107 forward link signal 119, which in the case of IS-95 for example comprises a synchronization channel and a pilot channel. The RF coupling 207 provides the forward link signal 119 to WAN receiver/decoder 201 which processes the signal to extract a timing reference 203 and a clock 205. The WAN receiver/decoder 201 provides the timing reference 203 and clock 205 to the access point 111 for purposes of synchronization.

It is important to all of the various embodiments of the present invention, that the WLAN access point 111 be synchronized with the signaling of mobile station 101 and its serving BTS 107, however there are various ways of accomplishing this which would still remain within the scope of the present invention. For example, although an expensive alternative, a GPS receiver may be provided and connected to access point 111 to provide a timing reference and clock. Another alternative example is to provide synchronization via the network 115 to the WLAN access point 111, since the WLAN access point via backhaul 113, 117 is already communicating with the WAN 105 in accordance with the embodiments.

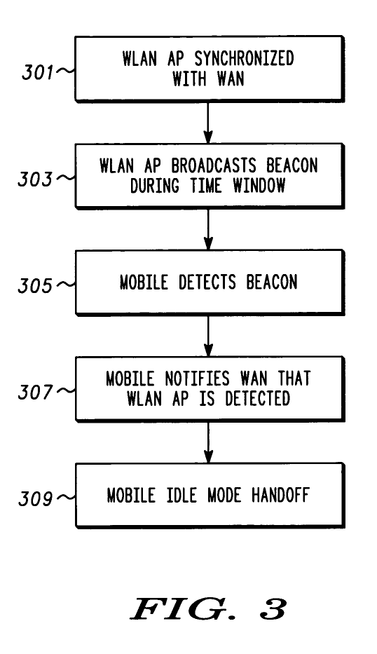

FIG. 3 is a flow diagram illustrating high level operation of a first embodiment of the present invention. In block 301, WLAN access point (AP) 111 is synchronized with WAN 105 as discussed above, either using WAN receiver/decoder 201 and forward link 119, or via backhaul connections and/or network 113, 115, and 117.

Based upon the synchronized timing, WLAN access point 111 broadcasts a beacon signal during a specific time window as shown in block 303. The WLAN access point 111 uses air interface 109 for transmitting the beacon. The mobile station 101, however will not normally have its air interface 109 transceiver equipment powered on at all times. During the predetermined time frame however, mobile station 101 will have powered on its air interface 109 transceiver to listen for a beacon signal. Depending on the configuration the listening may comprise a sweep of air interface 109 channels, or may comprise listening only to a specific air interface 109 channel during the predetermined time window.

After the mobile station 101 has detected any WLAN access points, including the WLAN access point 111 beacon as shown in block 305, mobile station 101 may compile a scan report as in 802.11 for example, however the timing parameters such as the Timestamp field may contain a special value for the synchronized WLAN access point 111 such that the mobile may report this value to the WAN 105 in block 307. However, any suitable indicator may be used that enables the WAN 105 to recognize and associate the reported indicator with WLAN access point 111 such that communications may continue between the WAN 105 and the mobile station 101 through the WLAN access point 111 and over the backhaul connections and or network 113, 115, and 117.

Because the mobile station 101 is already authorized and authenticated with the WAN 105 via air interface 103, the mobile station 101 may in some embodiments, perform association with WLAN access point 111 in an accelerated manner, that is, without joining and authentication procedures. Alternatively, the operation may be an 802.11 reassociation procedure in which the BTS 107 acts as a WLAN access point with respect to WLAN access point 111, via the backhaul communication between WLAN access point 111 and WAN 105. As shown in block 309, the mobile station idle mode messaging may be switched from air interface 103, to air interface 109 via WLAN access point 111. The mobile station 101 may subsequently power down its WAN transceiver equipment to save power.

It is to be understood that upon the mobile station 101 detecting the WLAN beacon from the access point 111 during the predetermined window, the handover process can move forward in any number of ways. For example, the mobile station 101 even during a WAN call can independently connect with the WLAN access point, and use it to route all the messaging back to the network and WAN to effect a handoff, which can be set to occur at a future moment. Alternatively, upon beacon detection, the mobile station 101 can communicate this information to the WAN which may then negotiate with the WLAN over the backhaul connections 113, 117 and network 115 to establish a transition of the mobile station 101 to the WLAN at a particular future moment. It should also be apparent that the final command to handoff can therefore be given to the mobile station either via the WLAN access point, the WAN communication, or both. The variety of possibilities becomes evident when one realizes that following detection of the beacon, the mobile device can engage in communications with the WAN and the WLAN simultaneously and independently. All that is needed is for the WAN and WLAN subsystems to coordinate subsequent communication.

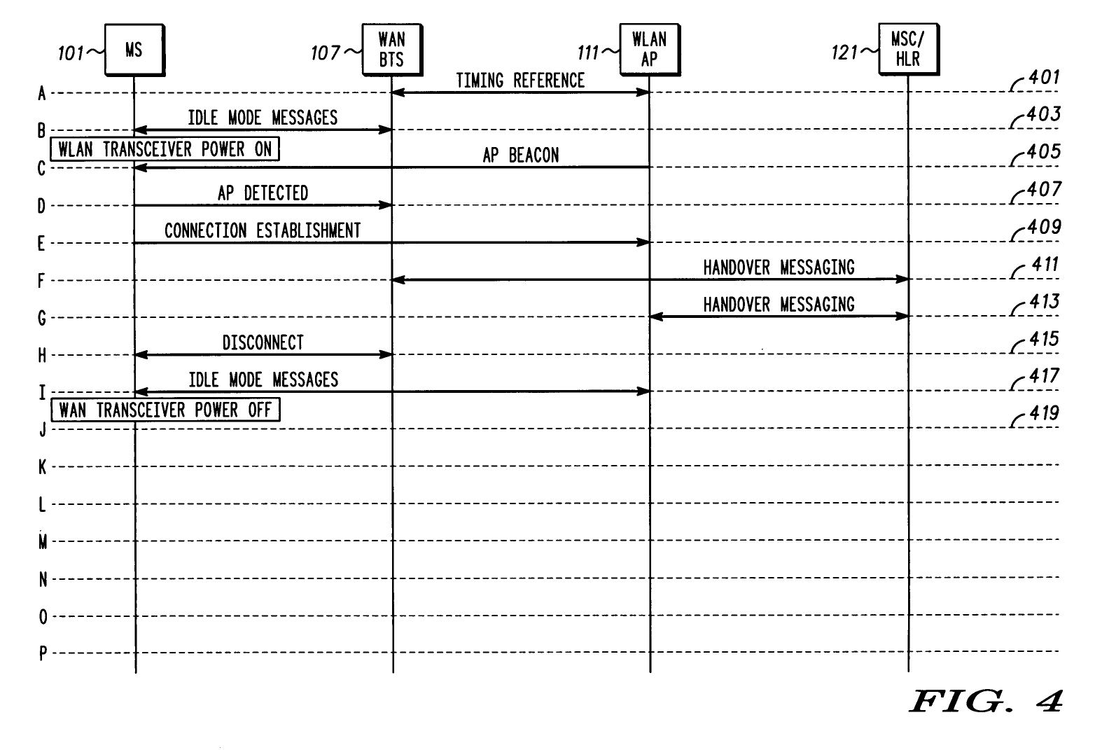

FIG. 4 is an exemplary message flow diagram illustrating further details of operation with respect to FIG. 3. In FIG. 4, the WAN BTS 107 and WLAN AP 111 share a common timing reference 401. The mobile station (MS) 101 transmits and receives idle mode messaging 403 to and from WAN BTS 107, respectively.

WLAN AP 111 transmits beacon 405 during a predetermined time window which is synchronized to the WAN and therefore likewise synchronized with the mobile station 101. Mobile station 101, having a priori knowledge of the time window, powers up its air interface 109 receiving equipment and listens for beacon 405. If mobile station 101 detects the beacon 405 it transmits message 407 to WAN BTS 107 over air interface 103 indicating the detection. Mobile station 101 then proceeds to establish a connection 409, which may be an 802.11 association as previously discussed. The WAN BTS 107 and MSC 121 perform necessary handover messaging 411, and messaging 413 between WLAN AP 111 and MSC 121, such that mobile station 101 is instructed to disconnect from WAN BTS 107 via messaging 415 and proceed with idle mode messaging 417 via air interface 109. The mobile station may subsequently power off its WAN transceiver equipment as shown by operation 419.

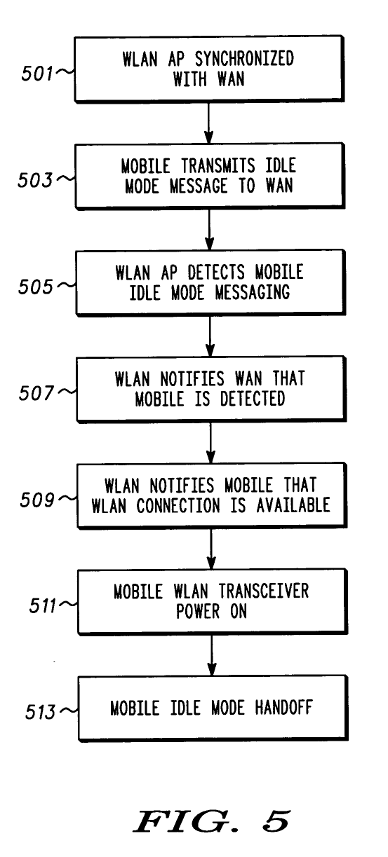

FIG. 5 is a flow diagram illustrating the high level operation of a second embodiment of the present invention. In block 501 the WLAN access point 111 is synchronized with WAN 105.

As previously discussed, the WLAN access point 111 may comprise a receiver for receiving and decoding the forward link of BTS 107 for synchronization purposes. However, in some embodiments synchronization between the WLAN access point 111 and the WAN 105 is accomplished using backhaul connections 113, 117, and network 115.

Because the WLAN access point 111 and mobile station 101 are synchronized to the same time reference, the WLAN access point 111 may detect short beacon bursts transmitted by the mobile station 101 during a predetermined time window.

For example, in a GSM WAN, idle mode messages are transmitted and received by BTS 107 over certain timeslots and frequencies. The BTS 107 may instruct the mobile station 101 to transmit a WLAN beacon burst, using air interface 109, during the same timeslot that idle mode information is received over air interface 103. Because WLAN access point 111 communicates with WAN 105 via a WAN receiver/decoder 201, and backhaul connections 113, 115, and 117 it can be informed by the WAN 105 of the appropriate timeslots and frequencies to monitor. The mobile station 101 may therefore conserve battery power by keeping its WLAN transceiver equipment powered off normally and powered on only for the short beacon transmission period.

In block 503, mobile station 101 may be operating in an idle mode with respect to WAN 105 and transmitting idle mode messaging to BTS 107 in accordance with the requirements of air interface 103. Additionally, in accordance with the second embodiment of the present invention, mobile station 101 may transmit a WLAN beacon signal over air interface 109 during a short time interval as instructed by BTS 107. When mobile station 101 is within a communication range of WLAN access point 111, the WLAN access point may detect a mobile station 101 WLAN beacon transmission over air interface 109 as shown in block 503.

In block 505, the WLAN access point 111 notifies the WAN 105, via backhaul connection 113, 115, and 117, that it has detected a mobile station 101 beacon. In block 507 the WAN notifies the mobile station 101 that WLAN access point 111 is nearby. In block 509 the mobile station 101 powers on its WLAN transceiver equipment and may associate with the access point. At this point it is in the same condition as in the previous embodiment and various alternatives in control and negotiation are possible to effect the handoff of the subscriber from the WAN to the WLAN. Ultimately, in block 511 the mobile station disconnects from the WAN BTS 107 and proceeds with idle mode messaging via WLAN access point 111 using air interface 109.

As discussed previously with respect to FIGS. 3 and 4, the mobile station 101 in some embodiments using 802.11 as air interface 109, may perform 802.11 association immediately in block 511 without joining or authentication because of the existing communication between WLAN access point 111 and WAN 105 via backhaul connections 113, 115, and 117. Alternatively, the mobile station 101 may perform an 802.11 reassociation in which BTS 107 appears as an 802.11 access point with respect to WLAN access point 111.

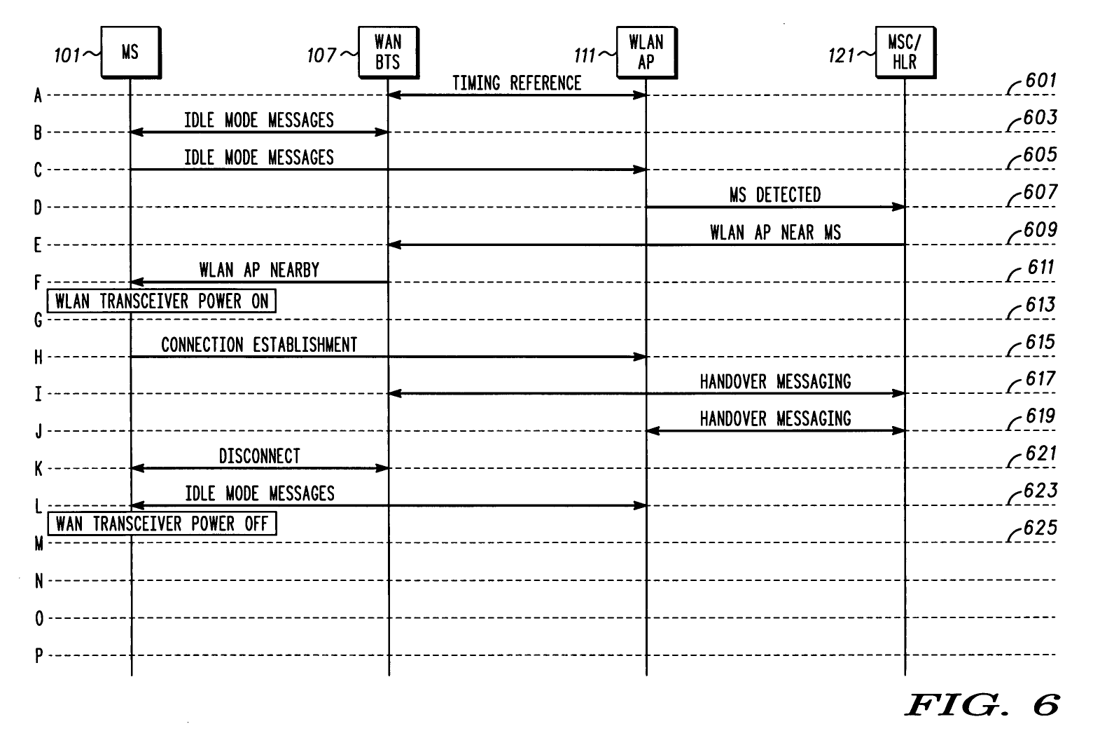

FIG. 6 is a flow diagram illustrating further details of operation with respect to FIG. 5. In FIG. 6, the WAN BTS 107 and WLAN AP 111 share a common timing reference 601. The mobile station 101 may be in an idle, transmitting and receiving idle mode messaging 603 to and from WAN BTS 107, respectively.

Because the WLAN access point 111 comprises the appropriate hardware and is aware of the correct times and frequencies to listen for mobile stations, it may detect a mobile station 101 beacon 605 by monitoring WLAN air interface 109.

After WLAN access point 111 detects the mobile station 101 beacon 605, it transmits a detection acknowledgment 607 to the MSC 121. The MSC 121 transmits notification message 609 to BTS 107, which subsequently transmits notification message 611 to mobile station 101 over air interface 103. The notification messages 607, 609 and 611 may contain the information of an 802.11 Probe Response in some embodiments, even though the WLAN access point 111 did not receive a formal Probe Request from the mobile station.

Additionally, because the mobile station 101 may be detected by multiple access points other than WLAN access point 111 it may receive multiple Probe Response information via messages like 611 and provide acknowledgement using air interface 109 in accordance with 802.11 procedures.

After receiving notification message 611, the mobile station 101 powers on its WLAN transceiver equipment in operation 613, and may establish a connection 615 in any appropriate procedure, for example 802.11 association, reassociation, etc. The WAN BTS 107 and WLAN access point 111 communicate with MSC 121 via handover messages 617 and 619, respectively, such that mobile station 101 disconnects 621 from BTS 107 and proceeds with idle mode messaging 623 using the WLAN access point 111 via air interface 109. The mobile station 101 may subsequently power off its WAN transceiver equipment as shown by operation 625.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method for handing over a mobile station from a Wide Area Network to a Wireless Local Area Network access point comprising:
receiving at the access point, a synchronization signal;
determining a broadcast time window based upon the synchronization signal;
monitoring during the broadcast time window for a mobile station beacon signal;
detecting the mobile station beacon signal; and
transmitting a notification message to the Wide Area Network that the mobile station beacon signal has been detected.

2. The method of claim 1 wherein step of determining a broadcast time window further comprises:
receiving a timing message from the Wide Area Network specifying the broadcast time window.

3. The method of claim 2 wherein the timing message is received over a backhaul connection between the Wide Area Network and the access point.

4. The method of claim 2 wherein the step of receiving at the access point, a synchronization signal, further comprises decoding at the access point at least one of a IS-95 forward link, GSM forward link, W-CDMA forward link, TD-SCDMA forward link and CDMA2000 forward link and obtaining the synchronization signal thereby.

5. The method of claim 2, wherein the step of monitoring during the broadcast time window for a mobile station beacon signal further comprises monitoring at least one of 802.11x, 802,15x, 802.16x, Bluetooth, and HomeRF radio frequencies.

6. A method for handing over a mobile station from a Wide Area Network to a Wireless Local Area Network access point comprising:
transmitting to the access point by the Wide Area Network a synchronization signal;
transmitting a timing message by the Wide Area Network to the access point specifying a time window in which the access point is to monitor for mobile station beacon signals;
transmitting a network message by the Wide Area Network to the mobile station specifying the time window in which the mobile station is to broadcast a beacon signal;
receiving a notification from the access point that the mobile station beacon signal has been detected; and
transmitting a command message to the mobile station commanding the mobile station to power on a Wireless Local Area Network transceiver and establish connection with the access point.

7. The method of claim 6 further comprising: determining a set of mobile stations that are within a location area nearby the access point, after receiving the notification that the mobile station beacon signal has been detected, and transmitting the command message to the set of mobile stations.

8. The mobile station of claim 6, wherein the notification from the access point comprises an identification element for the mobile station.

9. The method of claim 6, wherein the step of transmitting to the access point by the Wide Area Network a synchronization signal is accomplished using one of IS-95, GSM, W-CDMA, TD-SCDMA and CDMA2000.

10. The method of claim 6, wherein the step of transmitting a timing message by the Wide Area Network to the access point specifying a time window is accomplished using a backhaul connection.

11. A mobile station comprising:
a first transceiver for communicating via at least one of IS-95, GSM, W-CDMA, TD-SCDMA and CDMA2000;
a second transceiver for communicating via at least one of 802.11x, 802.15x, 802.16x, Bluetooth, and HomeRF; and
a processor and memory configured to receive a network message using the first transceiver, specifying a time window in which to transmit a beacon signal using the second transceiver, wherein the second transceiver is powered on initially only during the time window, and further configured to receive a notification using the first transceiver that a connection is available using the second transceiver, powering on the second transceiver and establishing a connection using the second transceiver.

12. The mobile station of claim 11, wherein the processor and memory are further configured to power off the first transceiver equipment subsequent to establishing the connection using the second transceiver.
